(19) United States
(12) Patent Application Publication
(10) Pub. No.: US 2006/0266941 A1
(43) Pub. Date: Nov. 30, 2006

(54) Method and apparatus for interfacing separations techniques to MALDI-TOF mass spectrometry

(76) Inventor: Marvin L. Vestal, Framingham, MA (US)

Correspondence Address: ELMORE PATENT LAW GROUP, PC, 209 MAIN STREET, N. CHELMSFORD, MA, 01863, US

(21) Appl. No.: 11/138,127

(22) Filed: May 26, 2005

(51) Int. Cl. H01J 49/04

(52) U.S. Cl. 250/288; 250/287; 250/282

(57) ABSTRACT

A sample plate for MALDI-TOF mass spectrography is provided which consists of a collimated hole structure intimately connected to a frame. The frame and at least one surface of the collimated hole structure are electrically conductive. The collimated hole structure may be formed from any material including glass, plastic, and metal and at least one surface may be rendered conductive by application of a thin layer of an electrically conductive material such as a metal, metal oxide, carbon, or organic or inorganic conductor or semi-conductor. The conductive surface is maintained in good electrical conduct with the conductive frame.

### FIELD OF THE INVENTION

This invention relates generally to the field mass spectrometry, and more particularly relates to matrix-assisted laser desorption/ionization time-of-flight mass spectrometry (hereinafter, “MALDI-TOF”).

### BACKGROUND OF THE INVENTION

It is generally accepted that mass spectrometry (“MS”) is essential for protein identification and characterization. Those of ordinary skill in the art will be aware that MALDI-TOF is a form of mass spectrometry that is typically the first method employed for protein identification. Mass spectrometry is used for the determination of accurate masses of peptides formed by enzymatic digestion in a technique known as peptide mass fingerprinting. Tandem MS-MS in various forms is used both as a more definitive method for identification and as the principal means for protein characterization. Two-dimensional (2-D) gel electrophoresis is, by far, the most widely accepted technique for high-resolution separation of protein mixtures, and recently, alternatives such as multi-dimensional high-performance liquid chromatography (“HPLC”) and capillary electrophoresis have been developed. Recent advances in MALDI-TOF mass spectrometry combined with advances in 2-D gel electrophoresis and other separation techniques promise to revolutionize the speed and sensitivity of the separation, quantitation, identification, and characterization of proteins in complex mixtures.

Tandem MS-MS is currently a popular method for characterizing proteins, although no single MS-MS instrument or technique appears to have established dominance. In these techniques, peptide mixtures are introduced into the mass spectrometer either as a continuous flow of a liquid solution, such as in nanospray, or as described below for MALDI-TOF. A molecular ion of interest is selected by the first MS. Ions are caused to fragment, usually by collision with a neutral gas, and the fragment ion masses and intensities are measured using the second MS. At present, most MS-MS applications employ triple quadrupoles, hybrid quadrupole-TOF systems, or ion traps, either quadrupole or magnetic (as in Fourier transform ion cyclotron resonance mass spectrometry (“FTICR”)). The techniques employ low energy collision-induced dissociation (“CID”), in which the ions are fragmented by a large number of relatively low energy collisions. An alternative technique is high energy CID in which the collision energy is sufficient to cause fragmentation as the result of a single collision, and the possible number of collisions that the ions undergo is small (i.e., <10). Prior to the development of tandem time-of-flight (TOF-TOF), high energy CID was available only on tandem magnetic sector instruments, or a hybrid of a magnetic sector with TOF. These instruments are complex and expensive, and are not readily interfaced with sensitive ionization techniques such as MALDI and electrospray.

Prior to the development of MALDI, combinations of separation techniques with mass spectrometry generally involved on-line direct coupling of the effluent from the chromatograph to the inlet of the mass spectrometer. Techniques such as electrospray, ionspray, and thermospray have been employed successfully with a variety of mass spectrometers, including TOF. In MALDI, samples are deposited on a surface, incorporated into crystals of a co-deposited matrix, and ions are desorbed directly into the gas phase by interaction with a pulsed laser beam. To interface MALDI with liquid separation techniques such as HPLC or capillary electrophoresis (“CE”), droplets from the liquid effluent, usually with added matrix solution, are deposited sequentially on a suitable surface and allowed to dry. The surface containing the dried matrix and samples is then inserted into the vacuum system of the MALDI mass spectrometer and irradiated by the laser beam. Many examples of suitable MALDI matrix materials are known in the art, including α-cyano-4-hydroxycinnamic acid, sinapinic acid, and 2-5 dihydrobenozoic acid. Some systems have been disclosed where the sample deposition takes place within the vacuum of the MS system and sample deposition and desorption are directly coupled. In some systems the liquid is deposited on the surface in a continuous track and the liquid rapidly evaporated in a vacuum.

The advantage of direct coupling between the separation and the MALDI mass spectrometer is that it behaves similarly to the more familiar direct coupling techniques such as electrospray, in that the time scales are the same. But this is also the main disadvantage of direct coupling. All of the measurements on an eluting peak must be made during the time that the peak is present in the effluent. Depending on the speed of the separation technique, this time may be as much as a minute or less than a second. In a typical measurement on a protein digest, this may involve measurement of the peptide mass fingerprint in MS mode, deciding which peaks should be measured using MS-MS, and measuring all of the MS-MS spectra of interest. This generally means that the separation must be slowed down to accommodate the speed of the mass spectrometer, or some of the potential information about the sample is lost.

In contrast, off-line coupling as in MALDI allows the sample deposition to occur at a speed appropriate to the chromatography, and the mass spectrometer can be operated faster or slower as needed to maximize the information. For example, an entire liquid chromatography (“LC”) run can be rapidly scanned to determine the peptide mass fingerprints and relative intensities for all peptides in the run. This information can then be used in a true data-dependent manner to set up the MS-MS measurement for all of the spots on the plate to obtain the required information most efficiently. Since it rare for all of the sample to be used in most MALDI measurements, additional measurements can be made at any later time as needed.

In many cases, samples of interest are distributed on a solid surface, for example in separations using 1-D or 2-D gel electrophoresis. Another example is direct imaging of tissue samples. Interfacing these samples with techniques such as electrospray require sampling of the solid surface, for example by cutting out a small piece, dissolving the samples and introducing them to the mass spectrometer, either directly or with separation. MALDI allows direct sampling of these solid samples using techniques such as the “molecular scanner,” or direct tissue imaging with MALDI using known techniques.

In early applications of MALDI-TOF, the samples were individually introduced on a solids probe and inserted into the ion source of the mass spectrometer. A wide variety of samples, including insulators, were analyzed without noticeable dependence on the nature of the sample surface. More recently, large numbers of samples are deposited on a sample plate, and the plate, when inserted into the mass spectrometer, forms one electrode of the applied accelerating field. In this case the sample plate must be sufficiently conductive to allow all of the plate surface to be maintained at substantially the potential of its holder despite the fact that ions of a particular polarity (either positive or negative) are desorbed from the surface by action of the pulsed laser beam. Also, since the sample plate is typically moved to sequentially bring different samples into the path of the laser, it is highly desirable that the plate be substantially flat so that the initial position of ion production is independent of the sample position on the plate. Variation in initial position of the ions causes the correlation between ion flight time and mass-to-charge ratio to vary, affecting calibration of the instrument, and in more extreme cases the resolving power of the instrument. In some applications of MALDI-TOF as currently practiced, such as the molecular scanner and tissue imaging, the sample surface may be a membrane or tissue slice that is neither flat nor electrically conductive.

### SUMMARY OF THE INVENTION

In view of the foregoing, the present invention is directed to an improved sample plate for use in performing MALDI.

In accordance with one aspect of the invention, a MALDI sample plate is provided in which the surface exposed to the laser beam in MALDI is substantially flat and electrically conductive. The sample plate comprises a substantially flat collimated hole structure connected to a frame.

In one embodiment, samples are preferentially dried in matrix crystals on the surface exposed to the laser beam independent of the method used for depositing and capturing samples on the sample plate.

Advantageously, and in accordance with still another aspect of the invention, no significant loss in spatial resolution occurs. Samples in dried matrix crystals are substantially located in the same position on the sample plate as in the original sample deposition.

In addition, individual sample locations are accurately located relative to reference positions on the sample plate or plate holder.

A sample plate in accordance with one embodiment of the invention provides high capacity for sample capture, enrichment, and modification without significant loss in spatial resolution or sample amount.

### BRIEF DESCRIPTION OF THE DRAWINGS

The foregoing and other features and aspects of the present invention will be best understood with reference to the following detailed description of specific embodiments of the invention, when read in conjunction with the accompanying drawings, wherein:

FIG. 1a is a side view of a MALDI sample plate in accordance with one embodiment of the invention;

FIG. 1b is a top view of the MALDI sample plate from FIG. 1;

FIG. 2 is a top view of a collimated hole structure which forms part of the sample plate from FIG. 1;

FIG. 3 is an enlarged view of the collimated hole structure from FIG. 2 showing the spacing of capillary-like holes extending transversely therethrough in one embodiment;

FIG. 4 is a side view of the MALDI sample plate from FIG. 1 schematically depicting the application of a sample to one surface thereof;

FIG. 5 is an enlarged side view of the collimated hole structure from FIG. 2 schematically depicting a sample capture and wash cycle;

FIG. 6 is a side view of the MALDI sample plate from FIG. 1 schematically depicting the application of a matrix solution to one surface thereof;

FIG. 7 is an enlarged view of the MALDI sample plate from FIG. 1 depicting the application of a matrix solution to one surface thereof and the elution of sample to another surface thereof;

FIG. 8 is a side view of the MALDI sample plate from FIG. 1 installed in a sample plate holder of a mass spectrometer;

FIG. 9 is a side view of the MALDI sample plate from FIG. 1 depicting the interface between the plate and a high-performance liquid chromatography (HPLC) column;

FIG. 10 is an enlarged view of the MALDI sample plate from FIG. 1 depicting the interface between the plate and a plurality of HPLC columns;

FIG. 11 is a side view of a pair of MALDI sample plates in accordance with one embodiment of the invention configured to transfer samples from gel or tissue slices using electrophoresis;

FIG. 12 is a side view of a pair of MALDI sample plates in accordance with one embodiment of the invention configured to transfer samples from tissue slices using electrophoresis;

FIG. 13 is a side view of a MALDI sample plate in accordance with an alternative embodiment of the invention and incorporating a permeable bottom for retaining samples;

FIG. 14 is a side view of a MALDI sample plate in accordance with another alternative embodiment of the invention configured in an apparatus for incubation of a protein array;

FIG. 15 is a side view of a pair of MALDI sample plates in accordance with one embodiment of the invention configured in an apparatus including a column block for extraction and parallel sample separation; and

FIG. 16 is a schematic diagram of a MALDI-TOF mass spectrometry system in accordance with one embodiment of the invention.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

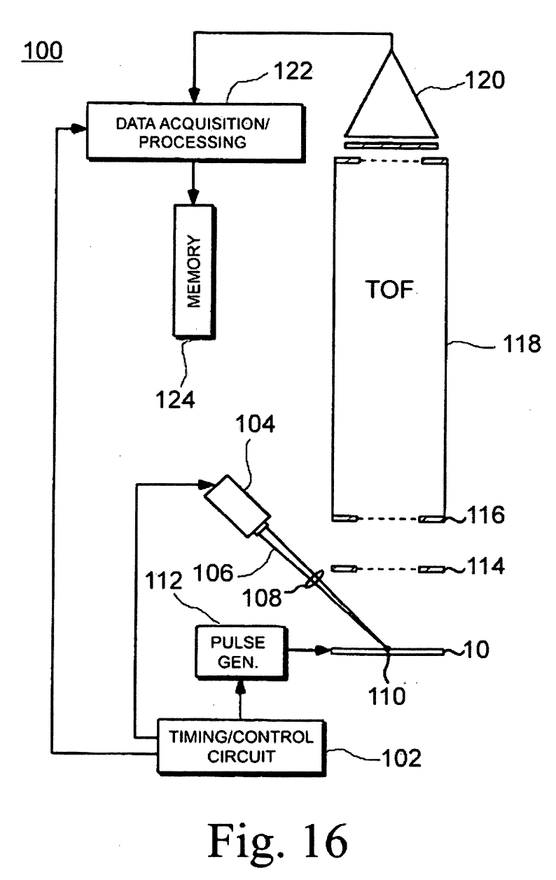

Referring first to FIG. 16, there is shown a simplified schematic diagram of a conventional matrix-assisted desorption/ionization time-of-flight (MALDI-TOF) mass spectrometer system 100 suitable for the purposes of the present invention. As shown in FIG. 16, system 100, a timing control circuit 102 activates a laser source 104. (Although only a single laser source 104 is shown in FIG. 16, those of ordinary skill in the art will recognize that systems with multiple laser sources may also be used.) Short laser pulses 106 are focused by a lens 108 onto a sample matrix 110 carried on a sample plate 10 to desorb and ionize the sample. At the same time, or after a short delay, a high voltage pulse or extraction pulse, generated by an extraction pulse circuit 112 is applied to sample plate 10 to generate a high electric field between sample plate 10 and an electrode 114, accelerating ions via electrode 116 toward a time-of-flight (TOF) mass analyzer 118. The ions travel through TOF mass analyzer 118 and are recorded by an ion detector 120, and a data acquisition system 122. The spectral data obtained are then preferably stored in a digital storage system 124 for analysis.

Those of ordinary skill in the art will be aware that there are a wide variety of mass analyzers known and commercially available from numerous sources, and with the benefit of the present disclosure will recognize that the invention as disclosed in various embodiments herein is by no means limited to a particular mass analysis system or apparatus.

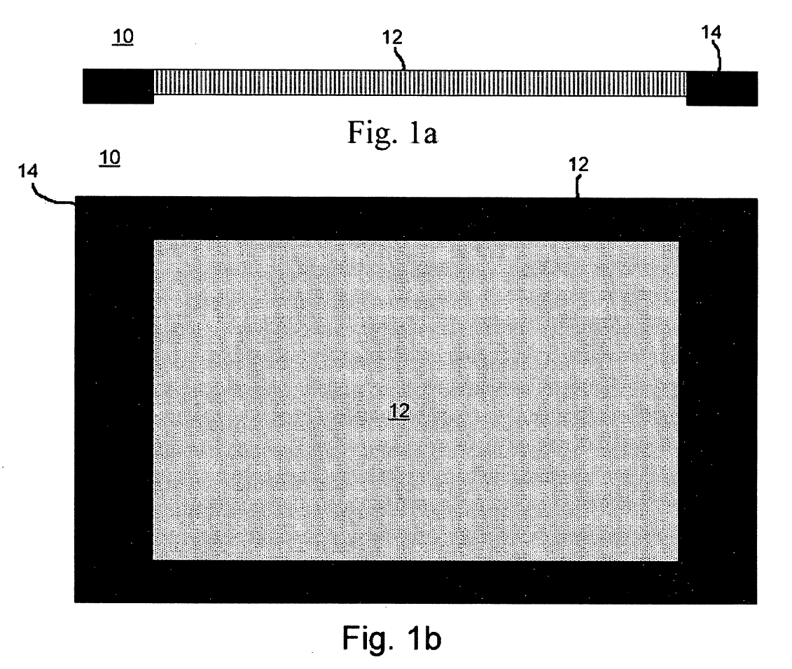

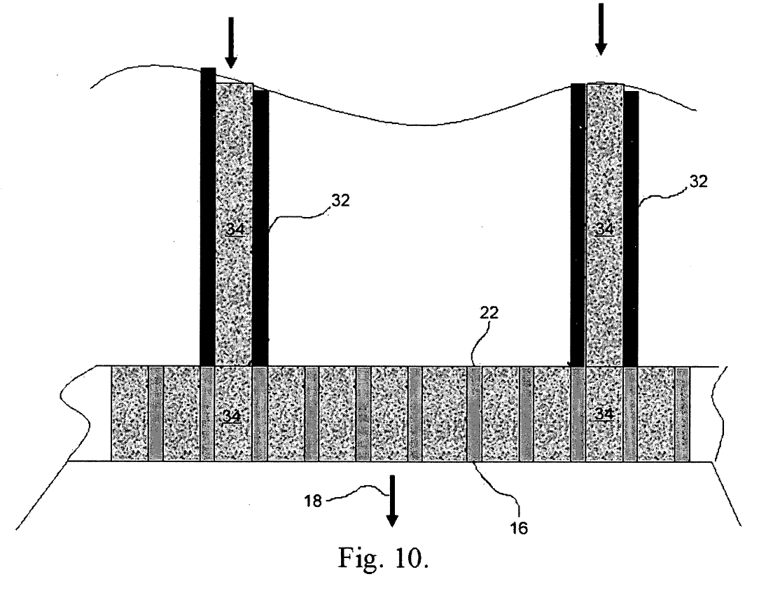

Turning now to FIGS. 1a and 1b, a side view of sample plate 10 in accordance with one embodiment of the invention is illustrated in FIG. 1a, and a top view of sample plate 10 is shown in FIG. 10b. The plate 10 consists of a collimated hole structure 12 intimately connected to a frame 14. Frame 14 and at least one surface of collimated hole structure 12 is electrically conductive. Collimated hole structure 12 may be formed from any material, including glass, plastic, polytetrafluoroethylene (PTFE, commercially known as Teflon®), and metal, and at least one surface may be rendered conductive by application of a thin layer of an electrically conductive material such as a metal, metal oxide, carbon, or organic or inorganic conductor or semi-conductor. Various techniques for forming collimated hole structures as described herein are known to those of ordinary skill in the art. Collimated Holes, Inc. in Campbell, Calif., is an example of a commercial entity that specializes in formation of collimated hole structures suitable for the purposes of the present invention. In all cases, the conductive surface is preferably in good electrical contact with frame 14, which is also conductive. In some embodiments, collimated hole structure 12 and frame 14 may be formed from a single piece of material, and if the material is nonconductive, then at least one surface must be made conductive by application of a thin layer of conductive material.

The dimensions of the frame and the thickness of frame 14 and collimated hole structure 12 are determined and/or limited by the dimensions of the sample plate accepted by the particular MALDI mass spectrometer to be used. In some embodiments the thickness of collimated hole structure 12 may be greater or less than the thickness of frame 14. In a preferred embodiment, the conductive surface of collimated hole structure 12 that is intended to be exposed to the laser beam is substantially coincident with that surface of frame 14. The material and dimensions of frame 14 are chosen to make it compatible with the sample plate holder used in a particular mass spectrometer. In one embodiment, frame 14 may be formed from magnetic stainless steel, and the outside dimensions chosen to be substantially the same as the standard sample plate for a particular instrument.

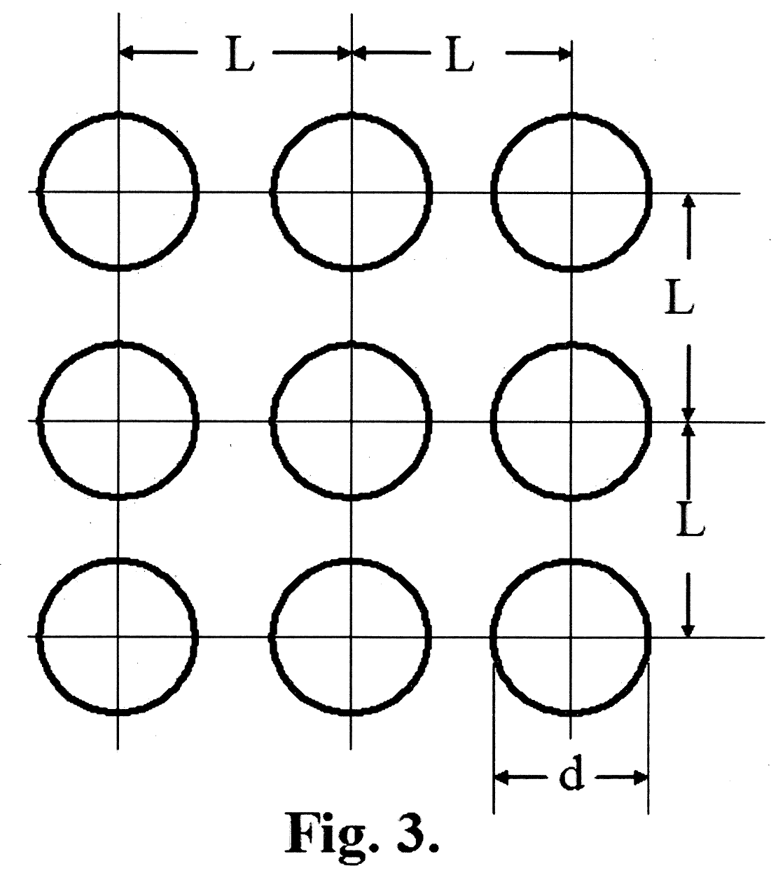

Collimated hole structure 12 comprises a flat plate with a plurality of holes extending through the plate. These holes are substantially parallel and uniform in diameter and spacing. In one embodiment the longitudinal axes of the holes are perpendicular to the surface; in another embodiment the axes of the holes may be inclined at an angle to the surface. A wide range of outside dimensions of the structure, diameter of the holes, spacing between the holes, and thickness of the plate can be employed depending on the application. The holes may be arranged in a square array as illustrated in FIG. 3, in a close-packed hexagonal array, or in any regular or irregular pattern.

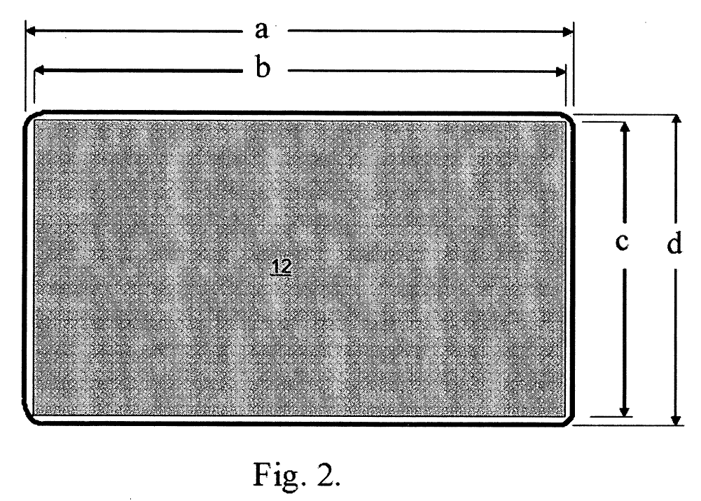

One embodiment of collimated hole structure 12 is shown in FIG. 2. As shown in FIG. 2, hole structure 12 has a small solid border surrounding the field of holes, although the holes can continue all the way to the edges of structure 12. Approximate dimensions of hole structure 12 in this exemplary embodiment are as set forth in the following Table 1:

TABLE 1

| REFERENCE | DIMENSION | |
|---|---|---|
| a | 111 | mm |
| b | 108 | mm |
| c | 72 | mm |
| d | 75 | mm |

FIG. 3 shows an illustrative hole pattern for hole structure 12 in the currently disclosed embodiment. Three examples of hole diameter, hole spacing, and plate thickness are set forth in the following Tables 2, 3 and 4.

TABLE 2
DIMENSIONS

| PLATE NO. | LENGTH (L) | DIAMETER (d) | THICKNESS |
|---|---|---|---|
| 1 | 1.125 mm | 1.00 mm | 8.0 mm |
| 2 | 0.025 mm | 0.050 mm | 1.5 mm |
| 3 | 0.010 mm | 0.025 mm | 1.5 mm |

TABLE 3
NUMBER OF HOLES

| PLATE | NO. | NO. | | |
|---|---|---|---|---|
| NO. | VERTICAL | HORIZONTAL | TOTAL | OAR |
| 1 | 64 | 96 | 6144 | 0.79 |
| 2 | 1440 | 2160 | 3.1 × 10⁶ | 0.20 |
| 3 | 2880 | 4320 | 12.4 × 10⁶ | 0.13 |

In Table 3 above, the term OAR refers to the open area ratio, equal to the fraction of the total area occupied by holes.

Those of ordinary skill in the art having the benefit of the present disclosure will appreciate that the invention is not limited to the foregoing examples, which are shown for purposes of illustration only. It is contemplated that any combination of these or other parameters may be appropriate for particular applications.

In one embodiment, the surface of the holes in collimated hole structure is the native material of the structure. In another embodiment the surface of the holes is modified by a chemical reaction. In another embodiment the surface of the holes may comprise an adsorbent material bonded to the surface. In still another embodiment, the holes may be packed with fine particles coated with an adsorbent material. In yet another embodiment, a monolithic support may be formed within the holes and coated with an absorbent material.

In this invention, any adsorbent material may be used, including, but not limited to, the materials used in liquid chromatography and electrophoresis, and materials that have high affinity for particular molecules. Many examples are known in the art. The adsorbent material chosen for a particular application must have sufficient affinity for molecules of interest in the solvent in which they are applied, yet allow them to be eluted in a solvent in which the matrix material is soluable. Many examples of suitable adsorbents and solvents are known in the art.

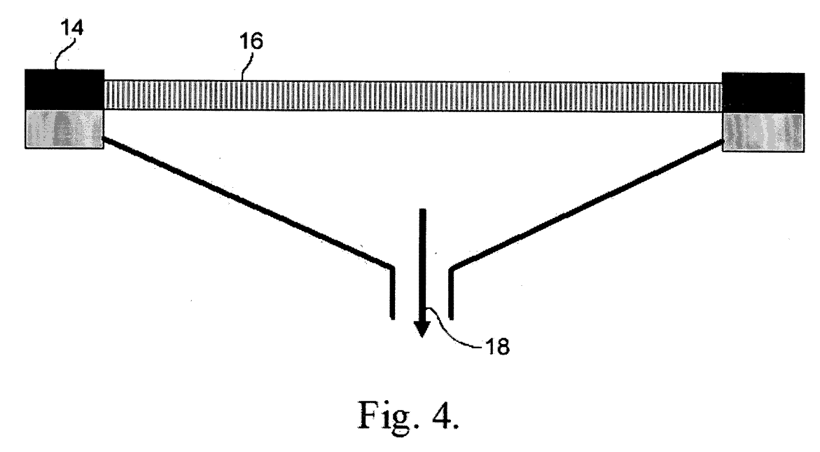

A general method for application of samples to the sample plate according to this invention is illustrated in FIG. 4. The first step is to dissolve a sample to be analyzed into an appropriate solvent to create a sample solution. The selection of a particular solvent may depend upon the type of sample to be analyzed, but may include, by way of example but not limitation, water containing salts or acids with organic modifiers or detergents, as would be apparent to those of ordinary skill in the art. The resulting sample solution is applied by any method to an upper surface 16 of sample plate 10. If only one surface 16 of the plate is electrically conductive, then the preferred method is to apply the sample solution to that surface. Sample solutions applied to a specific spot on the plate are drawn into the capillaries at that spot by capillary action, a pressure differential ΔP across the plate (as represented by arrow 18 in FIG. 4), or by electrophoresis. If the amount of liquid solution applied to a particular spot exceeds the volume of the capillaries in communication with that spot, then liquid passes through the plate, and depending on conditions may be expelled as liquid droplets or the liquid may be vaporized at the opposite surface from which it is applied. If the capillaries contain a sufficient quantity of a suitable adsorbent material, then portions of the sample of interest may be retained in the capillaries even though many capillary volumes of liquid may pass through.

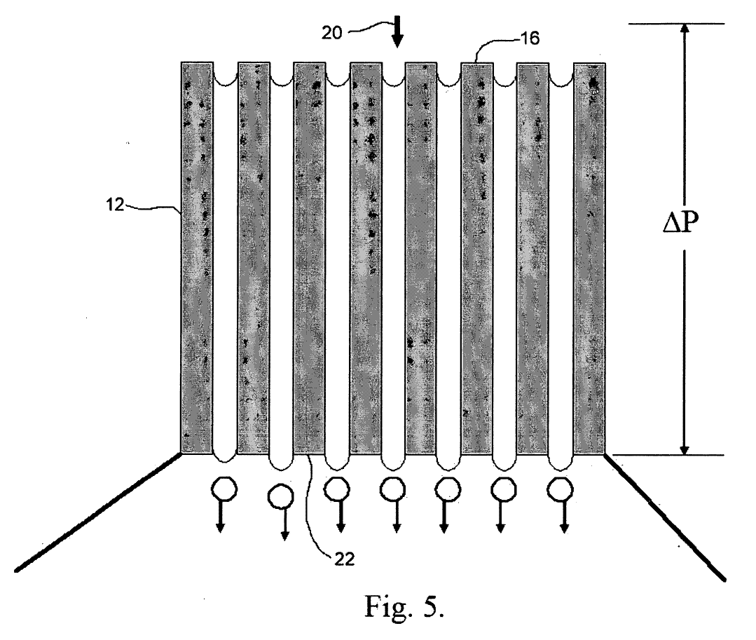

In some applications it may be desirable to remove salts from the capillaries without significantly removing the samples of interest. Washing away of salts can be accomplished by applying a suitable solvent, such as water, to all of the capillaries and forcing several capillary volumes through all of the capillaries simultaneously, as represented by arrow 20 in FIG. 5, which is an expanded side view of a portion of hole structure 12 schematically illustrating a sample capture and wash cycle. This process requires that the samples of interest are not eluted by the chosen solvent, and that conditions are chosen so that the excess solvent is expelled from the exit side 22 of hole structure 12 as liquid droplets and does not vaporize significantly on the entry side 16 of the sample plate. This requires that the flow rate of liquid through the capillary must be greater than the vaporization rate of a fully formed droplet at the exit side 22 from the capillary as illustrated in FIG. 5.

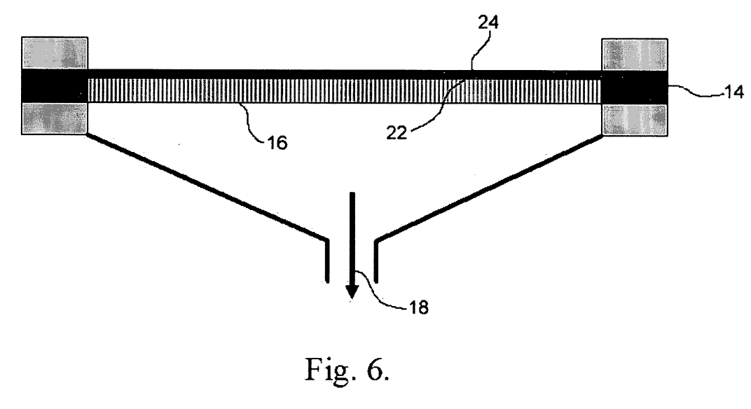

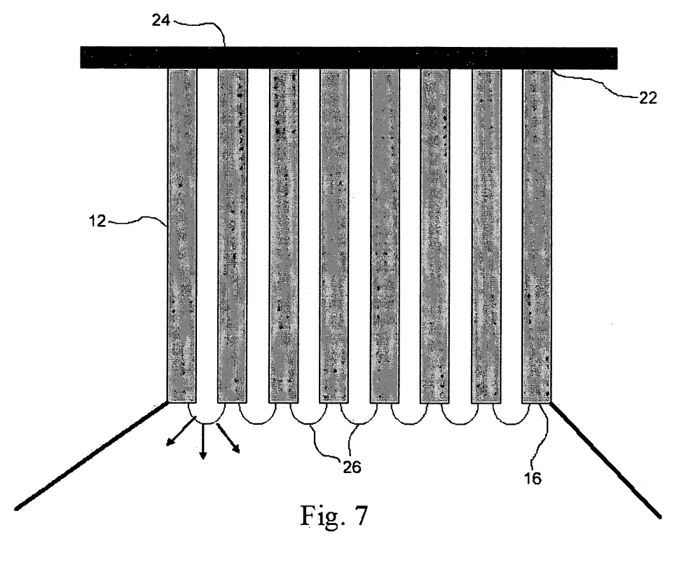

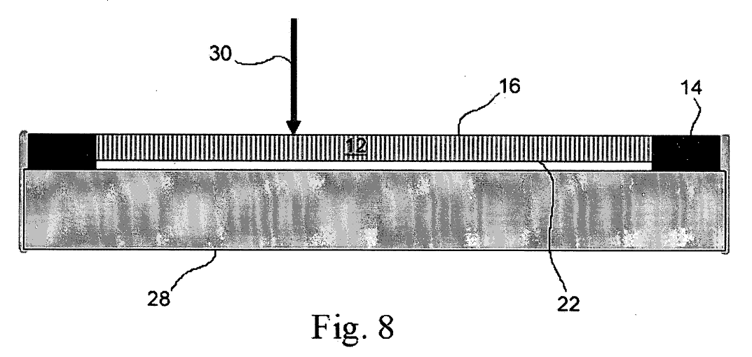

After the samples are captured in the capillary tubes of the sample plate, and washed as necessary, the sample plate is inverted and a dilute solution 24 of a chosen MALDI matrix is applied to the surface 22 opposite the electrically conductive surface 16 as illustrated in FIG. 6. The solvent in this step is chosen as one that efficiently elutes the samples of interest from the adsorbent material contained in the capillary. Conditions are chosen so that vaporization of the solvent does not occur within the capillary, but does occur at the surface 16 as illustrated in FIG. 7. For a given temperature and pressure of the vapor in the space adjacent to the surface 16, the vaporization rate is proportional to the area of liquid exposed. Since the surface area of an attached droplet 26 is between one and four times the cross-sectional area of the capillary, the range of flow rates meeting this vaporization condition is similar; thus it is relatively simple to control the pressure differential to meet this requirement. Crystals of matrix containing samples of interest are formed on the surface 16 surrounding the capillary exit, and as the last of the matrix solution is drawn through the capillaries crystals may fill the exit of the capillary. The sample plate 10 is then installed in the sample plate holder 28 for the MALDI mass spectrometer with the conductive surface 16 containing matrix crystals and samples of interest exposed to the laser beam 30 as illustrated in FIG. 8.

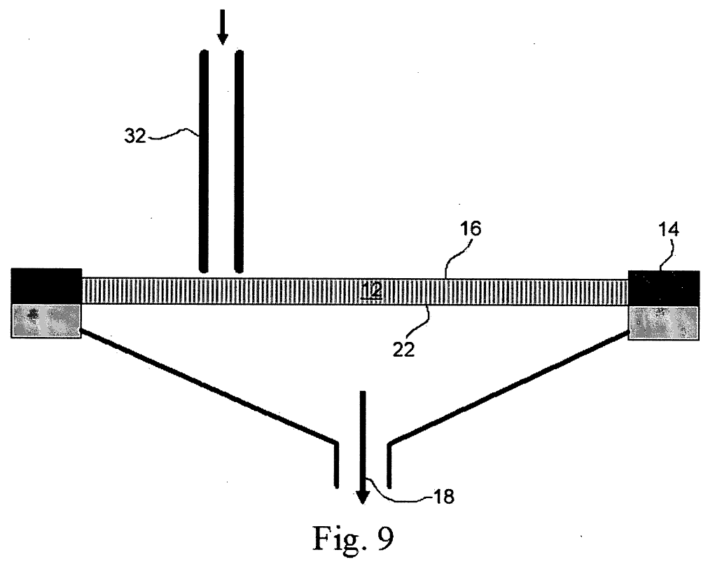

One embodiment of an interface of HPLC with a sample plate according to the present invention is illustrated in FIG. 9. In this embodiment, the effluent from one or more HPLC columns 32 is applied to conductive surface 16 of the sample plate, and the effluent is drawn into the capillaries in communication with the effluent. Samples of interest are adsorbed in the capillaries. One or more capillaries may be in communication with the liquid at any time and the position of plate 10 relative to HPLC effluent may be changed periodically so that a fresh portion of the plate is exposed to the effluent. Any arrangement of holes may be used, including but not limited to those depicted in FIG. 3. The capillaries may contain any adsorbent that retains the samples of interest, including the packing material used in the HPLC column. The flow rate through the capillaries may be larger or smaller than that required to prevent vaporization on the back side 22 of the plate 10 so long as the samples of interest are substantially retained in the capillaries.

A cross sectional view of a preferred embodiment of an interface of multiple HPLC columns to the sample plate 10 is illustrated in FIG. 10. This embodiment employs the hole spacing and thickness depicted as plate number 1 in FIG. 3. The holes or capillaries in hole structure 12 are filled with the same packing material 34 as the columns 32. In this embodiment, the spacing between the HPLC effluents is equal to eight times the spacing between holes, and the inner diameter of the columns 32 is equal to the inner diameter of the holes in hole structure 12. Any number of parallel columns up to 96 can be employed, but for full utilization of the plate the possible numbers are 1, 2, 3, 4, 6, 8, 12, 16, 24, 32, 48, and 96. The total number of distinct spots per chromatograph are 6144 divided by the number of columns. The plate is moved periodically so that the effluent is directed to an adjacent spot. In this embodiment the maximum time between movements, with no loss of sample, is equal to the thickness of the plate divided by the linear velocity through the packing. For a 1 mm column operated at 50 μL/min flow, the typical linear velocity is about 0.14 cm/sec. Thus, for the 8 mm thickness employed in this embodiment, the maximum time interval between movements is approximately 5.7 sec. This corresponds to a sample volume of 4.75 μL. More frequent sampling may be required to avoid loss in chromatographic resolution. Using the maximum time interval between samples approximately 10 hours of chromatography can be captured on a single plate. With smaller columns and corresponding higher hole density in the plate, the capacity of the plate can be increased substantially. For example with 70 micron diameter columns 32 and 100 micron spacing between holes, and the same linear velocity and plate thickness, 1214 hours of chromatography can be recorded on a single plate at maximum sampling time per spot. This corresponds to more than 12 hours each for 96 chromatographic channels. The final steps of eluting samples to the conductive surface in matrix solution and obtaining MALDI mass spectra are the same as described above.

Coupling of gel-filled capillary or open tubular capillary electrophoresis employs systems similar to those shown in FIGS. 9 and 10, except that the vacuum chamber and pressure driven flow is replaced by a buffer chamber and a pair of electrodes, and the flow is driven by a high voltage applied between the entrance to the columns and the exit from the plate.

This is particularly appealing for large numbers of high-performance parallel separations, since the apparatus for driving a large number of parallel capillaries electrophoretically is relatively simple and inexpensive. In one embodiment, the holes or capillaries in the plate 12 contain an adsorbing material that retains the samples of interest in the buffer solution used for the electrophoretic separation, e.g., reversed phase material. This allows samples to be concentrated in the capillaries and eluted to the conductive surface using a dilute matrix solution in organic solvent.

Slab gel electrophoresis is a preferred method for separating proteins. After proteins have been separated, it is often necessary to identify the proteins using mass spectrometry for determining the molecular weight of the intact proteins, and by peptide mass fingerprinting following enzymatic digestion and MS-MS identification of the peptides produced by digestion. At present, this requires a very slow and laborious process involving finding and cutting out a spot of interest, extracting the proteins in the spot, digesting the proteins, and individually transferring the samples to a mass spectrometer. A more efficient procedure has been proposed in the prior art that has been named the “molecular scanner”. In this procedure, a sandwich is formed consisting of the gel, a membrane containing an immobilized enzyme such as trypsin, and a capture membrane. Electro-blotting is employed to extract proteins from the gel and cause them to pass through the trypsin membrane where they are digested. The peptides produced are adsorbed on the capture membrane. Matrix solution is added to the membrane surface, usually by a spraying process. The capture membrane is then attached to a MALDI sample plate 10, plate 10 is loaded into the mass spectrometer, and peptide mass finger prints and MS-MS spectra can be measured for all of the proteins extracted from the gel. Protein molecular weight is not determined by mass spectrometry using this method.

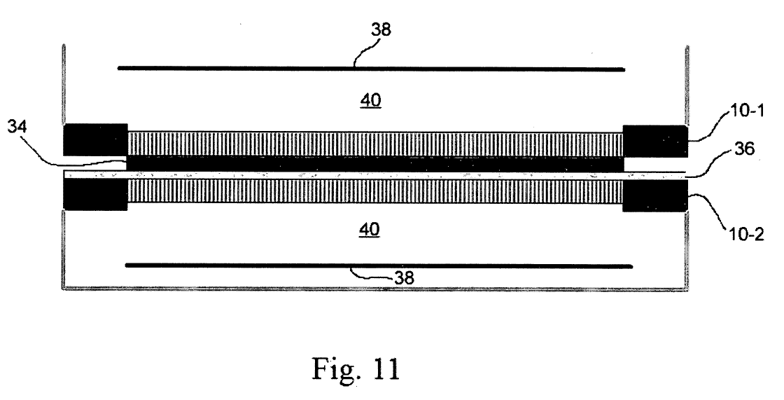

A perceived problem with this method is that peptides captured within the interior of the membrane are not efficiently transferred to the surface and incorporated into matrix crystals on the surface. Thus, a large fraction of the peptide sample is not accessible to the laser beam in the MALDI mass spectrometer, and the sensitivity is poor. An improved “molecular scanner” employing sample plates according to the present invention is illustrated in FIG. 11. In this system a sandwich is formed by two sample plates 10-1 and 10-2 on the outside with the gel 34 and the trypsin membrane 36 trapped in between the plates 10-1 and 10-2. The sample plate 10-1 adjacent to the gel on one side includes absorbent material in the capillaries suitable for capturing proteins of interest, and the plate 10-2 adjacent to the trypsin membrane includes absorbent material suitable for capturing peptides of interest.

The “sandwich” is disposed between a pair of electrodes 38, and is maintained in a buffer solution 40. Electro-blotting is employed initially with the polarity set so that a portion of proteins are transferred to the adjacent sample plate and captured. After a predetermined time, the polarity on electrodes 38 is reversed and proteins are transmitted into trypsin membrane 36 and digested. The peptides are captured on the second sample plate 10-2 adjacent to the membrane 36. The diameter of the capillary hole and the spacing between holes in hole structure 12 is determined by the spatial resolution required. In one embodiment, the spacing between holes is 25 microns and the hole diameter is 10 microns, corresponding to plate number 3 in FIG. 3. In an another embodiment 25 micron diameter holes are arranged in a hexagonal array with 35 micron spacing between holes.

After removal of the plates 10-1 and 10-2 from the sandwich and removing the gel 34 and membrane36, the plates 10-1 and 10-2 may be washed to remove salts as illustrated in FIG. 5. The final steps of eluting samples to the conductive surface in matrix solution and obtaining MALDI mass spectra are the same as described above. With the laser beam adjusted to a diameter corresponding to the distance between holes in the plate (e.g., approximately 25 microns), mass spectra can be determined for each hole in the plate. The molecular weight of the proteins is determined by the spectra from the first plate 10-1, and peptide mass fingerprints and MS-MS spectra from the second plate 10-2. Both high sensitivity and high resolution are obtained because all of the sample at each position is contained in matrix crystals formed in the immediate vicinity of the hole.

Those of ordinary skill in the art will appreciate that the foregoing approach is not limited to gels, but can be applied to any application in which samples are deployed on or in a permeable surface such as a membrane or frit.

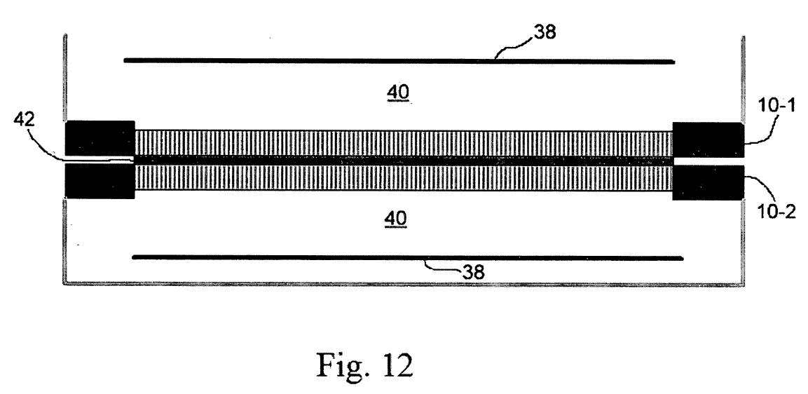

It has been proposed in the prior art to perform direct tissue imaging by MALDI mass spectrometry. In such techniques, thin slices of tissue are sprayed with MALDI matrix and attached to the sample plate of MALDI mass spectrometer, and mass spectra of the proteins and or small molecules contained in the tissue are measured. This has clearly shown the potential for many important applications, but it is believed that considerable work remains to develop a complete integrated system that can be used routinely. One of the problems with the method is that extraction of samples and incorporation into matrix crystals is rather inefficient, and the conditions for extraction and formation of matrix crystals on a surface accessible to laser desorption are limited by the properties of the tissue specimen and the need to maintain spatial resolution. The apparatus illustrated in FIG. 12 allows these limitations to be overcome.

The approach depicted in FIG. 12 allows the choice of extraction conditions for a tissue slice 42 to be optimized without regard to the choice of matrix and leaves the samples in matrix crystals on a flat, conductive surface that is ideal for MALDI-TOF. The details of the MALDI sample plate depend, to some extent, on the application and the spatial resolution required, but a configuration such as depicted as hole arrangement #2 in FIG. 3. appears to be a reasonable choice in many cases. Sample slices 42 may be deposited on one such plate 10-2 and the position of the slices and the regions of interest may be recorded using a microscope with digital video readout. This allows the position of the sample slices to be determined relative to the hole array, and video observation of the sample in the mass spectrometer is then not required. The slices 42 may then be covered with a thin inert membrane or filter paper and sandwiched with another sample plate 10-1 as illustrated in FIG. 12. For extraction of soluble proteins by electrophoresis, as illustrated in FIG. 12, the plate 10-2 with the mounted samples may have untreated glass capillaries and the capillaries in the other plate 10-1 may contain a bonded stationary phase suitable for adsorbing proteins under reversed phase conditions. Voltage is applied across electrodes 38 so that electro-osmotic flow carries extracted proteins from the tissue 42 into the capillaries containing the adsorbent. SDS or other suitable detergent can be added to the mobile phase so long as it does not prevent the proteins from being captured in the capillaries.

After elution is complete, the plate 10-1 that has captured the proteins may be washed to remove residual detergent and salts, and matrix solution added as described above to elute the proteins to the conductive surface and incorporate them into matrix crystals. This approach allows any matrix to be used, including α-cyano-4-hydroxycinnamic acid, which is the preferred matrix for lower mass proteins but which has not been successfully used with the conventional approaches to tissue imaging. For other classes of proteins, such as membrane proteins, pressure driven elution with different solvent and capture media can be used. This approach may allow multiple extractions of a single tissue slice to optimize extraction of specific types of proteins from the tissue.

Tissue imaging can also be done using an apparatus such as depicted in FIG. 11, except that the gel 34 is replaced by a tissue slice. Proteins extracted from the tissue pass through the trypsin membrane 36 and are captured in the capillaries of a sample plate 10-2. The final steps of eluting samples to the conductive surface in matrix solution and obtaining MALDI MS and MS-MS mass spectra are the same as described above for use will gels.

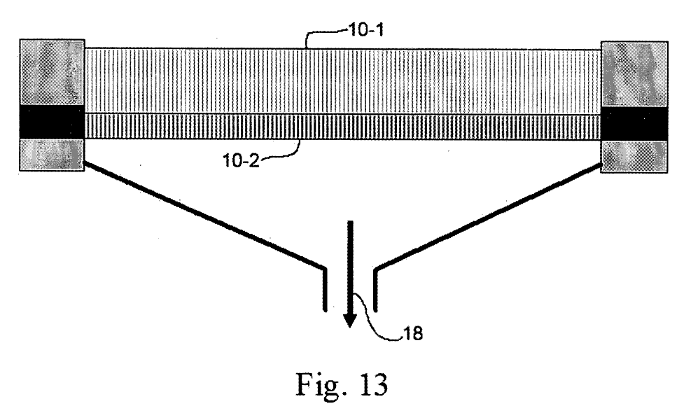

Sample plates in accordance with the present invention can be used with any type of plate for capturing and parallel processing of samples in which the number of sample wells in the capturing and processing plate is less than or equal to the number of holes in the sample plate. In preferred embodiments the sample wells are arranged in one of the standard micro-plate formats comprising 96, 384, 1536, and 6144 wells arranged in a regular array 72×108 mm in dimension. A preferred sample plate for this application employs the hole array depicted as plate number 1 in FIG. 3. In a preferred embodiment, the wells in the capturing and processing plate include a permeable bottom such as a membrane or frit that retains the samples in the well, but allows the samples to be transferred to the MALDI sample plate by application of a pressure differential or by electrophoresis. In some embodiments the capture and processing plate may comprise a standard, commercially available microplate in 96, 384, 1536, or 6144 format. This application is illustrated schematically in FIG. 13, which shows sample plate 10-2 and a capture and processing plate 10-1. If the number of wells in the processing plate is less than the number of holes in the sample plate, then the mechanism must include the capability (not shown) for positioning each of a series of processing plates with wells 10-1 relative to the MALDI sample plate 10-2. For example, the samples contained in 64 capturing and processing plates with 96 wells each can be transferred to a single 6144 hole sample plate by positioning the well plates at each of 64 locations within a 9 mm square. After transferring and capturing samples in the MALDI sample plates, the samples may be washed, eluted to the conductive surface with matrix solution, and mass spectra obtained as described above.

The used of DNA and RNA arrays to detect and quantify nucleic acids in complex biological samples is well established. There is great interest in similar techniques for proteins and peptides, but these have been less successful. In the array approach, a large number of addressable positions on a surface are each provided with a different molecular structure. Complex samples of interest are incubated with the array, the array is washed to remove non-specific binding, and the amount of material bound to each element of the array determined by an appropriate analytical technique such as laser-induced fluorescence. There are many problems in applying this technology to proteins and peptides, but perhaps the most important is that detection techniques such as currently employed with DNA arrays are inadequate for identifying and quantifying proteins and small molecules bound to each element. MALDI mass spectrometry can provide the necessary analytical capabilities, but the sensitivity and specificity achieved has so far been inadequate.

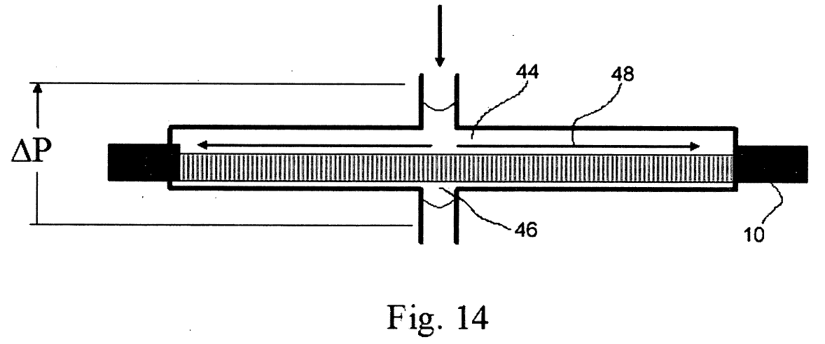

The MALDI sample plates in accordance with the present invention provide a practical method for overcoming these limitations. The number of addressable elements by this approach is almost unlimited. Using the geometry depicted as plate number 3 in FIG. 3, more than 12 million distinct elements could be formed. A more practical array may be that depicted as plate number 1 in FIG. 3, having 6144 elements. This number could be increased to 24,576 by decreasing the hole size and spacing by a factor of 2, or to 98,304 by decreasing the spacing and diameter of the holes by a factor of 4. Arrays can be formed by employing the techniques described above for transferring samples from micro-plates to the MALDI sample plates. The array plate may then be installed in an apparatus such as depicted in FIG. 14, and the sample in liquid solution may be exposed to the array. In one embodiment of FIG. 14, the sample plate 10 has 6144 elements packed with an appropriate adsorbent, each loaded with a different protein binder irreversibly attached to the adsorbent. Each element has a void volume of approximately 5 μL. Thus, about 30 mL of solution is required to saturate the plate 10, and with the added chambers 44 and 46 above and below the plate 10, the total volume of the system may be on the order of 50 mL. A stirrer 48 may be included in at least one of the liquid chamber (chamber 44 in FIG. 14), and means is provided for introducing a pressure differential ΔP between the two liquid chambers 44 and 46. The pressure difference is periodically reversed so that the liquid flows back and forth through the elements of the arrays, and in combination with stirrer 48 this process is repeated so that all of the solution makes contact with all of the elements of the array. If necessary, a large number of the elements (ca. half of the total) could be loaded with specific binders for the major components present in the sample (e.g. albumin) so that non-specific binding of the major components does not overwhelm specific binding of minor components. After incubation is complete, the plate 10 can be washed to deplete nonspecific binders and to remove salts. Matrix solution may then be added to elute samples to the conductive surface, and MALDI mass spectra obtained as described in more detail above. Also an array plates with captured samples can be installed in a sandwich such as depicted in FIG. 11 (but without the gel) and the samples digested and the resulting peptides captured on a second MALDI sample plate. Analysis of the spots on sample plate by MALDI MS-MS allows unambiguous identification and quantitation of the samples bound to each element of the array.

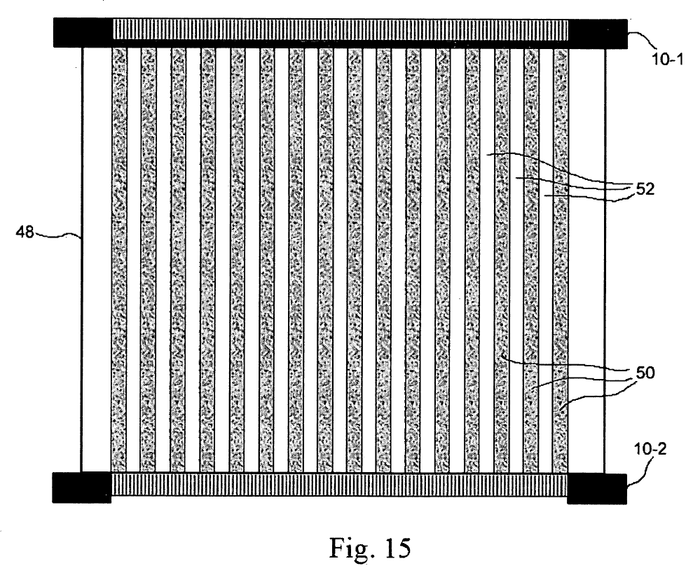

In some cases, such as tissue imaging, a large number of different proteins may be present in each spot sampled, and using the techniques in accordance with the present invention, it may be possible to detect and identify only the more abundant proteins. The dynamic range and the number of proteins detected and identified can be increased by separating or fractionating the sample prior to detection by the MALDI-TOF mass spectrometer. This can be accomplished using an apparatus such as depicted in FIG. 15.

The apparatus of FIG. 15 comprises a combination of extraction from a gel or tissue using apparatus such as illustrated in FIGS. 11 or 12 with parallel separation as shown schematically in FIG. 10. Flow may be driven electrophoretically by application of a voltage difference or by a pressure differential. The tissue slice 42 is mounted on the top sample plate 10-1 as in FIG. 12, but a column block 48 containing multiple columns 50 and thereby defining multiple parallel separation channels 52 is clamped between the top and bottom sample plates 10-1 and 10-2 as shown in FIG. 15. In one embodiment the hole pattern in the top plate 10-1 is substantially identical to that of the parallel separation channels 52. For example, an array of 384 holes, each 0.5 mm in diameter spaced 4.5 mm in a square array within an area 72×108 mm can be used. The hole pattern in the bottom sample plate 10-2 generally contains a larger number of holes of similar diameter but more closely spaced so that multiple fractions of components eluting from the separation channels can be captured on suitable adsorbents contained in the holes of the second sample plate. For example the second sample plate might include 24,576 holes of 0.5 mm diameter arranged in a regular 72×108 mm array with 0.625 mm spacing. This would allow 64 fractions separated from each of the 384 spots selected on the tissue to be analyzed by MALDI by moving the bottom plate 10-2 over a range of 4.5×4.5 mm in 0.625 mm increments.

In some cases it may be desirable to analyze the entire tissue sample. Up to 64 different positions within each 4.5×4.5 mm segment can be done by using a different bottom sample plate for each new position of the top sample plate, and using a top sample plate also containing the 24,576 hole configuration. Complete analysis of the entire 72×108 mm tissue sample with 0.625 mm resolution would generate 64 sample plates for analysis by MALDI, or a total of 1,572,864 spots. With an MS system capable of generating 50 spectra/sec this complete analysis requires about 9 hours.

For protein identification a tryptic membrane may be added to the sandwich as shown FIG. 11, and MS and MS-MS spectra of the tryptic peptides may be generated by MALDI-TOF MS and MS-MS.

From the foregoing detailed description of specific embodiments of the invention, it should be apparent that methods and apparatuses for MALDI-TOF mass spectrometric analysis using a collimated hole structure sample plate have been disclosed. Although specific embodiments of the invention have been disclosed herein in detail, this has been done solely to describe various features and aspects of the invention, and is not intended to be limiting with respect to the scope of the invention. It is contemplated that various substitutions, alterations, and modifications may be made to the embodiments disclosed herein, including but not limited to those implementation variations and alternatives that have been specifically discussed herein, without departing from the spirit and scope of the invention as defined in the appended claims, which follow.

What is claimed is:

1. A sample plate for mass spectrometry, comprising a collimated hole structure.

2. A sample plate in accordance with claim 1, wherein the collimated hole structure is incorporated into a frame adapted for mounting in a mass spectrometer.

3. A sample plate in accordance with claim 2, wherein at least one surface of the sample plate is substantially flat.

4. A sample plate in accordance with claim 2, wherein at least one surface of the sample plate is electrically conductive.

5. A sample plate in accordance with any of claims 1 through 4, wherein holes in said collimated hole structure are arranged substantially parallel along their longitudinal axes and are uniform in diameter and spacing.

6. A sample plate in accordance with claim 5 wherein said holes are substantially perpendicular to at least one surface of said collimated hole structure.

7. A sample plate in accordance with to claim 1 wherein holes in said collimated hole structure contain an adsorbent material.

8. A sample plate in accordance with claim 7, wherein said adsorbent material comprises a material used in columns for liquid chromatography.

9. A sample plate in accordance with claim 7, wherein said adsorbent material comprises a material used in electrophoresis.

10. A sample plate in accordance with claim 7, wherein said adsorbent material comprises a material used for affinity capture.

11. A sample plate in accordance with claim 7, wherein said adsorbent material is bonded to interior surfaces of said holes in said collimated hole structure.

12. A sample plate in accordance with claim 7, wherein said adsorbent material is bonded to fine particles packed into said holes in said collimated hole structure.

13. A sample plate in accordance with claim 7, wherein said adsorbent material is bonded to a monolithic support formed within said holes in said collimated hole structure.

14. A sample plate in accordance with claim 1, wherein said collimated hole structure is formed from glass.

15. A sample plate in accordance with claim 1, wherein said collimated hole structure is formed from fused silica.

16. A sample plate in accordance with claim 1, wherein said collimated hole structure is formed from quartz.

17. A sample plate in accordance with claim 1, wherein said collimated hole structure is formed from plastic.

18. A sample plate in accordance with claim 1, wherein said collimated hole structure is formed from PVC.

19. A sample plate in accordance with claim 1, wherein said collimated hole structure is formed from PEAK.

20. A sample plate in accordance with claim 1, wherein said collimated hole structure is formed from polyethylene.

21. A sample plate in accordance with claim 1, wherein said collimated hole structure is formed from polypropylene.

22. A sample plate in accordance with claim 1, wherein said collimated hole structure is formed from polycarbonate.

23. A sample plate in accordance with claim 1, wherein said collimated hole structure is formed from polytetrafluoroethylene (PTFE).

24. A sample plate in accordance with claim 1, wherein said collimated hole structure is formed from metal.

25. A sample plate in accordance with claim 2 wherein said frame is formed from magnetic material.

26. A sample plate in accordance with claim 25 wherein said frame is formed from stainless steel.

27. A MALDI mass spectrometer system, comprising:
a laser source for delivering a laser pulse to a sample under analysis;
a pulse generator for delivering an electrical pulse to said sample, thereby accelerating ions;
a time-of-flight mass spectrometer, including at least one electrode for accelerating said ions toward an ion detector; and
data acquisition and processing circuitry, coupled to said ion detector, for deriving a mass spectra corresponding to said sample;
wherein said sample is carried on a sample plate comprising a collimated hole structure.

28. A MALDI mass spectrometer system in accordance with claim 27, wherein said sample plate is a sample plate in accordance with any one of claims 1 through 26.

29. A method for analyzing a sample, comprising:
introducing said sample into a liquid solution to produce a sample solution;
applying said sample solution to a surface of a sample plate comprising a collimated hole structure, whereby said sample solution is drawn into capillaries in said collimated hole structure;
capturing portions of said sample within said capillaries in said collimated hole structure;
applying a solution containing a matrix for MALDI mass spectrometry to said surface, causing portions of said sample and matrix to be eluted from said holes onto a conductive surface of said collimated hole structure;
drying said eluted sample and matrix on said electrically conductive surface, thereby forming matrix crystals containing said sample; and
installing said sample plate with matrix crystals in a MALDI mass spectrometer such that said matrix crystals are exposed to a laser beam in said spectrometer;
performing spectrometric analysis of said matrix crystals such that mass spectra of said samples are recorded.
